(19) United States
(12) Patent Application Publication
(10) Pub. No.: US 2020/0045305 A1
(43) Pub. Date: Feb. 6, 2020

(54) PICTURE PROCESSING METHOD AND APPARATUS FOR SAME

(71) Applicant: LG ELECTRONICS INC., Seoul (KR)

(72) Inventors: Hyeongmoon JANG, Seoul (KR); Junghak NAM, Seoul (KR); Jaehyun LIM, Seoul (KR)

(73) Assignee: LG Electronics Inc., Seoul (KR)

(21) Appl. No.: 16/337,867

(22) PCT Filed: Sep. 29, 2017
(86) PCT No.: PCT/KR2017/010994

§ 371 Date: Mar. 28, 2019

Related U.S. Application Data
(60) Provisional application No. 62/401,911, filed on Sep. 30, 2016.

(51) Int. Cl. H04N 19/103; H04N 19/119; H04N 19/186; H04N 19/176; H04N 19/70; H04N 19/61

(52) U.S. Cl. CPC H04N 19/103; H04N 19/119; H04N 19/61; H04N 19/176; H04N 19/70; H04N 19/186

(57) ABSTRACT

Disclosed is a method for processing an image and an apparatus therefor in the present invention. Particularly, a method for decoding an image may include generating a prediction block of a current processing block by using a prediction mode of the current processing block, wherein the current processing block indicates a block in which a leaf node block partitioned into a quadtree structure from a basic unit partitioning a picture is partitioned into a binary tree structure; determining whether a skip mode is applied to the current processing block; and generating a residual block of the current processing block, when the skip mode is not applied for the current processing block, wherein the step of generating the residual block includes decoding a syntax element indicating whether a residual signal is existed in a chroma component of the current processing block.

### CROSS-REFERENCE TO RELATED APPLICATIONS

This application is the National Stage filing under 35 U.S.C. 371 of International Application No. PCT/KR2017/010994, filed on Sep. 29, 2017, which claims the benefit of U.S. Provisional Applications No. 62/401,911, filed on Sep. 30, 2016, the contents of which are all hereby incorporated by reference herein in their entirety.

### TECHNICAL FIELD

The present invention relates to a method for processing a still image or moving image and, more particularly, to a method for transmitting residual signal information by considering a block partition structure and an apparatus supporting the same.

### BACKGROUND ART

Compression encoding means a series of signal processing techniques for transmitting digitized information through a communication line or techniques for storing information in a form suitable for a storage medium. The medium including a picture, an image, audio, etc. may be a target for compression encoding, and particularly, a technique for performing compression encoding on a picture is referred to as video image compression.

Next-generation video contents are supposed to have the characteristics of high spatial resolution, a high frame rate and high dimensionality of scene representation. In order to process such contents, a drastic increase in the memory storage, memory access rate and processing power will result.

Accordingly, it is required to design a coding tool for processing next-generation video contents efficiently.

### DISCLOSURE

### Technical Problem

An object of the present invention is to propose a method for transmitting residual signal information efficiently by considering Quadtree plus binarytree (QTBT) structure.

In addition, an object of the present invention is to propose a method for designing Coded Bit Flag (CBF) syntax indicating whether a residual signal is existed in accordance with the QTBT structure.

In addition, an object of the present invention is to propose a method for representing a residual signal without a syntax transmitted from a higher layer in a compression technique in which there is no division of an encoding unit, a prediction unit and a transform unit.

In addition, an object of the present invention is to propose a method for representing Advanced Motion Vector Prediction (AMVP) residual signal efficiently.

Technical objects to be achieved in the present invention are not limited to the above-described technical objects, and other technical objects not described above may be evidently understood by a person having ordinary skill in the art to which the present invention pertains from the following description.

### Technical Solution

According to an aspect of the present invention, a method for decoding an image may include generating a prediction block of a current processing block by using a prediction mode of the current processing block, wherein the current processing block indicates a block in which a leaf node block partitioned into a quadtree structure from a basic unit partitioning a picture is partitioned into a binary tree structure; determining whether a skip mode is applied to the current processing block; and generating a residual block of the current processing block, when the skip mode is not applied for the current processing block, wherein the step of generating the residual block includes decoding a syntax element indicating whether a residual signal is existed in a chroma component of the current processing block.

Preferably, the step of generating the residual block may include decoding a syntax element indicating whether a residual signal is existed in a luma component of the current processing block, when a residual signal is existed in the chroma component.

Preferably, when a residual signal is not existed in the chroma component, wherein the residual signal may be estimated to be existed in the luma component

Preferably, the method may further include determining whether a merge mode is applied to the current processing block, when a prediction mode of the current processing block is an inter-prediction mode; and decoding a reference picture index and a motion vector difference value of the current processing block, when the merge mode is not applied to the current processing block, wherein the step of generating the residual block includes: decoding an Advanced Motion Vector Prediction (AMVP) skip flag indicating that a decoding syntax of a residual block is not existed in an AMVP mode.

Preferably, the step of generating the residual block may include decoding a syntax element indicating whether a residual signal is existed in a luma component of the current processing block, when the AMVP flag indicates 0 and the residual signal is not existed in the chroma component.

According to another aspect of the present invention, an apparatus for decoding an image may include a prediction block generation unit for generating a prediction block of a current processing block by using a prediction mode of the current processing block, wherein the current processing block indicates a block in which a leaf node block partitioned into a quadtree structure from a basic unit partitioning a picture is partitioned into a binary tree structure; a skip mode determination unit for determining whether a skip mode is applied to the current processing block; and a residual block generation unit for generating a residual block of the current processing block, when the skip mode is not applied for the current processing block, wherein the residual block generation unit decodes a syntax element indicating whether a residual signal is existed in a chroma component of the current processing block.

Preferably, the residual block generation unit may decode a syntax element indicating whether a residual signal is existed in a luma component of the current processing block, when a residual signal is existed in the chroma component.

Preferably, when a residual signal is not existed in the chroma component, wherein the residual signal may be estimated to be existed in the luma component.

Preferably, the apparatus may further include a merge mode determination unit for determining whether a merge mode is applied to the current processing block, when a prediction mode of the current processing block is an inter-prediction mode; and a motion information decoding unit for decoding a reference picture index and a motion vector difference value of the current processing block, when the merge mode is not applied to the current processing block, wherein the residual block generation unit decodes an Advanced Motion Vector Prediction (AMVP) skip flag indicating that a decoding syntax of a residual block is not existed in an AMVP mode.

Preferably, the residual block generation unit may decode a syntax element indicating whether a residual signal is existed in a luma component of the current processing block, when the AMVP flag indicates 0 and the residual signal is not existed in the chroma component.

### Technical Effects

According to the present invention, a syntax representing whether there is a residual signal is efficiently designed, and accordingly, encoding efficiency may be improved.

Technical effects which may be obtained in the present invention are not limited to the technical effects described above, and other technical effects not mentioned herein may be understood to those skilled in the art from the description below.

### DESCRIPTION OF DRAWINGS

The accompanying drawings, which are included herein as a part of the description for help understanding the present invention, provide embodiments of the present invention, and describe the technical features of the present invention with the description below.

FIG. 1 is illustrates a schematic block diagram of an encoder in which the encoding of a still image or video signal is performed, as an embodiment to which the present invention is applied.

FIG. 2 illustrates a schematic block diagram of a decoder in which decoding of a still image or video signal is performed, as an embodiment to which the present invention is applied.

FIG. 3 is a diagram for describing a split structure of a coding unit that may be applied to the present invention.

FIG. 4 is a diagram for describing a prediction unit that may be applied to the present invention.

FIG. 5 is an embodiment to which the present invention may be applied and is a diagram illustrating the direction of inter-prediction.

FIG. 6 is an embodiment to which the present invention may be applied and illustrates integers for ¼ sample interpolation and a fraction sample locations.

FIG. 7 is an embodiment to which the present invention may be applied and illustrates the location of a spatial candidate.

FIG. 8 is an embodiment to which the present invention is applied and is a diagram illustrating an inter-prediction method.

FIG. 9 is a diagram for describing a method of decoding a syntax indicating whether a residual signal is present as an embodiment to which the present invention may be applied.

FIG. 10 is a diagram for describing a syntax signaled for representing whether a residual signal is present according to a partition depth of a transform unit as an embodiment to which the present invention may be applied.

FIG. 11 is a diagram for describing the problem occurred as a syntax indicating whether a residual signal is present is transmitted in a higher level as an embodiment to which the present invention may be applied.

FIG. 12 is a diagram for describing a method of transmitting a syntax indicating whether a residual signal is present directly for each component as an embodiment to which the present invention may be applied.

FIG. 13 is a diagram for describing syntax for supporting skip in an AMVP mode as an embodiment to which the present invention may be applied.

FIG. 14 is a diagram for describing a method for decoding an image according to an embodiment of the present invention.

FIG. 15 is a diagram illustrating a decoding apparatus of a picture according to an embodiment of the present invention in detail.

### MODE FOR INVENTION

Hereinafter, a preferred embodiment of the present invention will be described by reference to the accompanying drawings. The description that will be described below with the accompanying drawings is to describe exemplary embodiments of the present invention, and is not intended to describe the only embodiment in which the present invention may be implemented. The description below includes particular details in order to provide perfect understanding of the present invention. However, it is understood that the present invention may be embodied without the particular details to those skilled in the art.

In some cases, in order to prevent the technical concept of the present invention from being unclear, structures or devices which are publicly known may be omitted, or may be depicted as a block diagram centering on the core functions of the structures or the devices.

Further, although general terms widely used currently are selected as the terms in the present invention as much as possible, a term that is arbitrarily selected by the applicant is used in a specific case. Since the meaning of the term will be clearly described in the corresponding part of the description in such a case, it is understood that the present invention will not be simply interpreted by the terms only used in the description of the present invention, but the meaning of the terms should be figured out.

Specific terminologies used in the description below may be provided to help the understanding of the present invention. Furthermore, the specific terminology may be modified into other forms within the scope of the technical concept of the present invention. For example, a signal, data, a sample, a picture, a frame, a block, etc may be properly replaced and interpreted in each coding process.

Hereinafter, in this specification, a “processing unit” means a unit in which an encoding/decoding processing process, such as prediction, transform and/or quantization, is performed. Hereinafter, for convenience of description, a processing unit may also be called “processing block” or “block.”

A processing unit may be construed as having a meaning including a unit for a luma component and a unit for a chroma component. For example, a processing unit may correspond to a coding tree unit (CTU), a coding unit (CU), a prediction unit (PU) or a transform unit (TU).

Furthermore, a processing unit may be construed as being a unit for a luma component or a unit for a chroma component. For example, the processing unit may correspond to a coding tree block (CTB), coding block (CB), prediction block (PB) or transform block (TB) for a luma component. Alternatively, a processing unit may correspond to a coding tree block (CTB), coding block (CB), prediction block (PU) or transform block (TB) for a chroma component. Also, the present invention is not limited to this, and the processing unit may be interpreted to include a unit for the luma component and a unit for the chroma component.

Furthermore, a processing unit is not essentially limited to a square block and may be constructed in a polygon form having three or more vertices.

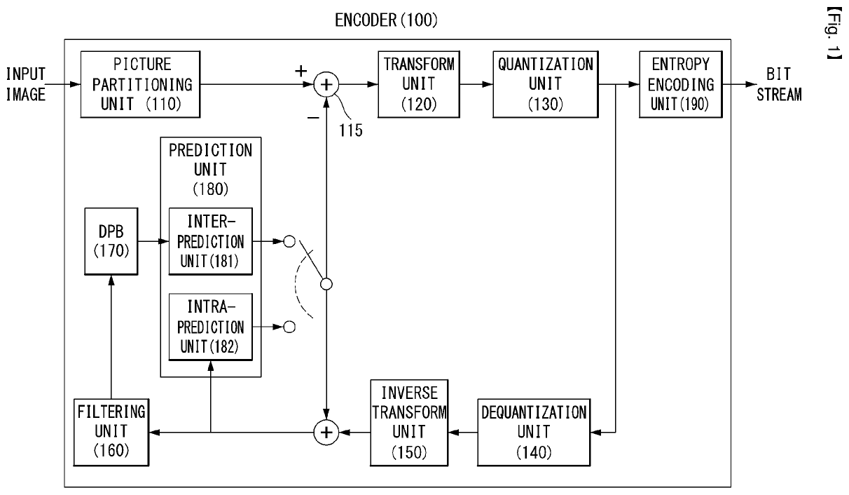

FIG. 1 is illustrates a schematic block diagram of an encoder in which the encoding of a still image or video signal is performed, as an embodiment to which the present invention is applied.

Referring to FIG. 1, the encoder 100 may include a video split unit 110, a subtractor 115, a transform unit 120, a quantization unit 130, a dequantization unit 140, an inverse transform unit 150, a filtering unit 160, a decoded picture buffer (DPB) 170, a prediction unit 180 and an entropy encoding unit 190. Furthermore, the prediction unit 180 may include an inter-prediction unit 181 and an intra-prediction unit 182.

The video split unit 110 splits an input video signal (or picture or frame), input to the encoder 100, into one or more processing units.

The subtractor 115 generates a residual signal (or residual block) by subtracting a prediction signal (or prediction block), output by the prediction unit 180 (i.e., by the inter-prediction unit 181 or the intra-prediction unit 182), from the input video signal. The generated residual signal (or residual block) is transmitted to the transform unit 120.

The transform unit 120 generates transform coefficients by applying a transform scheme (e.g., discrete cosine transform (DCT), discrete sine transform (DST), graph-based transform (GBT) or Karhunen-Loeve transform (KLT)) to the residual signal (or residual block). In this case, the transform unit 120 may generate transform coefficients by performing transform using a prediction mode applied to the residual block and a transform scheme determined based on the size of the residual block.

The quantization unit 130 quantizes the transform coefficient and transmits it to the entropy encoding unit 190, and the entropy encoding unit 190 performs an entropy coding operation of the quantized signal and outputs it as a bit stream.

Meanwhile, the quantized signal outputted by the quantization unit 130 may be used to generate a prediction signal. For example, a residual signal may be reconstructed by applying dequatization and inverse transformation to the quantized signal through the dequantization unit 140 and the inverse transform unit 150. A reconstructed signal may be generated by adding the reconstructed residual signal to the prediction signal output by the inter-prediction unit 181 or the intra-prediction unit 182.

Meanwhile, during such a compression process, neighbor blocks are quantized by different quantization parameters. Accordingly, an artifact in which a block boundary is shown may occur. Such a phenomenon is referred to a blocking artifact, which is one of important factors for evaluating image quality. In order to decrease such an artifact, a filtering process may be performed. Through such a filtering process, the blocking artifact is removed and the error of a current picture is decreased at the same time, thereby improving image quality.

The filtering unit 160 applies filtering to the reconstructed signal, and outputs it through a playback device or transmits it to the decoded picture buffer 170. The filtered signal transmitted to the decoded picture buffer 170 may be used as a reference picture in the inter-prediction unit 181. As described above, an encoding rate as well as image quality can be improved using the filtered picture as a reference picture in an inter-picture prediction mode.

The decoded picture buffer 170 may store the filtered picture in order to use it as a reference picture in the inter-prediction unit 181.

The inter-prediction unit 181 performs temporal prediction and/or spatial prediction with reference to the reconstructed picture in order to remove temporal redundancy and/or spatial redundancy.

Particularly, the inter-prediction unit 181 according to the present invention may use inverse direction motion information in the process of inter-prediction (or prediction between pictures). The detailed description is described below.

In this case, a blocking artifact or ringing artifact may occur because a reference picture used to perform prediction is a transformed signal that experiences quantization or dequantization in a block unit when it is encoded/decoded previously.

Accordingly, in order to solve performance degradation attributable to the discontinuity of such a signal or quantization, signals between pixels may be interpolated in a sub-pixel unit by applying a low pass filter to the inter-prediction unit 181. In this case, the sub-pixel means a virtual pixel generated by applying an interpolation filter, and an integer pixel means an actual pixel that is present in a reconstructed picture. A linear interpolation, a bi-linear interpolation, a wiener filter, and the like may be applied as an interpolation method.

The interpolation filter may be applied to the reconstructed picture, and may improve the accuracy of prediction. For example, the inter-prediction unit 181 may perform prediction by generating an interpolation pixel by applying the interpolation filter to the integer pixel and by using the interpolated block including interpolated pixels as a prediction block.

The intra-prediction unit 182 predicts a current block with reference to samples neighboring the block that is now to be encoded. The intra-prediction unit 182 may perform the following procedure in order to perform intra-prediction. First, the intra-prediction unit 182 may prepare a reference sample necessary to generate a prediction signal. Furthermore, the intra-prediction unit 182 may generate a prediction signal using the prepared reference sample. Furthermore, the intra-prediction unit 182 may encode a prediction mode. In this case, the reference sample may be prepared through reference sample padding and/or reference sample filtering. A quantization error may be present because the reference sample experiences the prediction and the reconstruction process. Accordingly, in order to reduce such an error, a reference sample filtering process may be performed on each prediction mode used for the intra-prediction.

The prediction signal (or prediction block) generated through the inter-prediction unit 181 or the intra-prediction unit 182 may be used to generate a reconstructed signal (or reconstructed block) or may be used to generate a residual signal (or residual block).

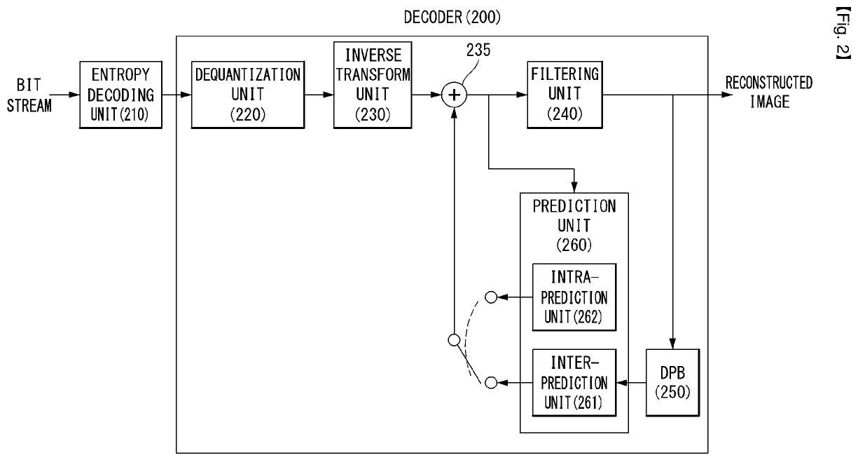

FIG. 2 illustrates a schematic block diagram of a decoder in which decoding of a still image or video signal is performed, as an embodiment to which the present invention is applied.

Referring to FIG. 2, the decoder 200 may include an entropy decoding unit 210, a dequantization unit 220, an inverse transform unit 230, an adder 235, a filtering unit 240, a decoded picture buffer (DPB) 250 and a prediction unit 260. Furthermore, the prediction unit 260 may include an inter-prediction unit 261 and an intra-prediction unit 262.

Furthermore, a reconstructed video signal output through the decoder 200 may be played back through a playback device.

The decoder 200 receives a signal (i.e., bit stream) output by the encoder 100 shown in FIG. 1. The entropy decoding unit 210 performs an entropy decoding operation on the received signal.

The dequantization unit 220 obtains transform coefficients from the entropy-decoded signal using quantization step size information.

The inverse transform unit 230 obtains a residual signal (or residual block) by inverse transforming the transform coefficients by applying an inverse transform scheme.

The adder 235 adds the obtained residual signal (or residual block) to the prediction signal (or prediction block) output by the prediction unit 260 (i.e., the inter-prediction unit 261 or the intra-prediction unit 262), thereby generating a reconstructed signal (or reconstructed block).

The filtering unit 240 applies filtering to the reconstructed signal (or reconstructed block) and outputs the filtered signal to a playback device or transmits the filtered signal to the decoded picture buffer 250. The filtered signal transmitted to the decoded picture buffer 250 may be used as a reference picture in the inter-prediction unit 261.

In this specification, the embodiments described in the filtering unit 160, inter-prediction unit 181 and intra-prediction unit 182 of the encoder 100 may be identically applied to the filtering unit 240, inter-prediction unit 261 and intra-prediction unit 262 of the decoder, respectively.

Particularly, the inter-prediction unit 261 according to the present invention may use inverse direction motion information in the process of inter-prediction (or prediction between pictures). The detailed description is described below.

Processing Unit Split Structure

In general, a block-based image compression method is used in the compression technique (e.g., HEVC) of a still image or a video. The block-based image compression method is a method of processing an image by splitting it into specific block units, and may decrease memory use and a computational load.

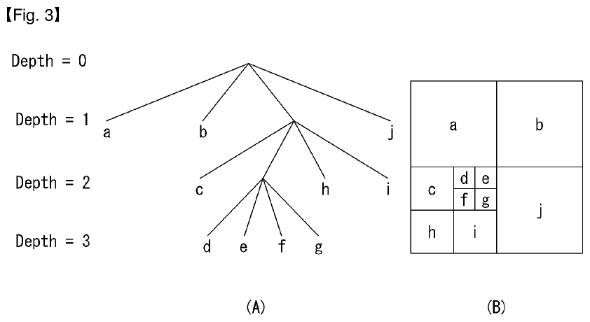

FIG. 3 is a diagram for describing a split structure of a coding unit which may be applied to the present invention.

An encoder splits a single image (or picture) into coding tree units (CTUs) of a quadrangle form, and sequentially encodes the CTUs one by one according to raster scan order.

In HEVC, a size of CTU may be determined as one of 64×64, 32×32, and 16×16. The encoder may select and use the size of a CTU based on resolution of an input video signal or the characteristics of input video signal. The CTU includes a coding tree block (CTB) for a luma component and the CTB for two chroma components that correspond to it.

One CTU may be split in a quad-tree structure. That is, one CTU may be split into four units each having a square form and having a half horizontal size and a half vertical size, thereby being capable of generating coding units (CUs). Such splitting of the quad-tree structure may be recursively performed. That is, the CUs are hierarchically split from one CTU in the quad-tree structure.

A CU means a basic unit for the processing process of an input video signal, for example, coding in which intra/inter prediction is performed. A CU includes a coding block (CB) for a luma component and a CB for two chroma components corresponding to the luma component. In HEVC, a CU size may be determined as one of 64×64, 32×32, 16×16, and 8×8.

Referring to FIG. 3, the root node of a quad-tree is related to a CTU. The quad-tree is split until a leaf node is reached. The leaf node corresponds to a CU.

This is described in more detail. The CTU corresponds to the root node and has the smallest depth (i.e., depth=0) value. A CTU may not be split depending on the characteristics of an input video signal. In this case, the CTU corresponds to a CU.

A CTU may be split in a quad-tree form. As a result, lower nodes, that is, a depth 1 (depth=1), are generated. Furthermore, a node (i.e., leaf node) that belongs to the lower nodes having the depth of 1 and that is no longer split corresponds to a CU. For example, in FIG. 3(b), a CU(a), a CU(b) and a CU(j) corresponding to nodes a, b and j have been once split from the CTU, and have a depth of 1.

At least one of the nodes having the depth of 1 may be split in a quad-tree form. As a result, lower nodes having a depth 1 (i.e., depth=2) are generated. Furthermore, a node (i.e., leaf node) that belongs to the lower nodes having the depth of 2 and that is no longer split corresponds to a CU. For example, in FIG. 3(b), a CU(c), a CU(h) and a CU(i) corresponding to nodes c, h and i have been twice split from the CTU, and have a depth of 2.

Furthermore, at least one of the nodes having the depth of 2 may be split in a quad-tree form again. As a result, lower nodes having a depth 3 (i.e., depth=3) are generated. Furthermore, a node (i.e., leaf node) that belongs to the lower nodes having the depth of 3 and that is no longer split corresponds to a CU. For example, in FIG. 3(b), a CU(d), a CU(e), a CU(f) and a CU(g) corresponding to nodes d, e, f and g have been three times split from the CTU, and have a depth of 3.

In the encoder, a maximum size or minimum size of a CU may be determined based on the characteristics of a video image (e.g., resolution) or by considering the encoding rate. Furthermore, information about the maximum or minimum size or information capable of deriving the information may be included in a bit stream. A CU having a maximum size is referred to as the largest coding unit (LCU), and a CU having a minimum size is referred to as the smallest coding unit (SCU).

In addition, a CU having a tree structure may be hierarchically split with predetermined maximum depth information (or maximum level information). Furthermore, each split CU may have depth information. Since the depth information represents a split count and/or degree of a CU, it may include information about the size of a CU.

Since the LCU is split in a Quad-tree shape, the size of SCU may be obtained by using a size of LCU and the maximum depth information. Or, inversely, the size of LCU may be obtained by using a size of SCU and the maximum depth information of the tree.

For a single CU, the information (e.g., a split CU flag (split_cu_flag)) that represents whether the corresponding CU is split may be forwarded to the decoder. This split information is included in all CUs except the SCU. For example, when the value of the flag that represents whether to split is ‘1’, the corresponding CU is further split into four CUs, and when the value of the flag that represents whether to split is ‘0’, the corresponding CU is not split any more, and the processing process for the corresponding CU may be performed.

As described above, a CU is a basic unit of the coding in which the intra-prediction or the inter-prediction is performed. The HEVC splits the CU in a prediction unit (PU) for coding an input video signal more effectively.

A PU is a basic unit for generating a prediction block, and even in a single CU, the prediction block may be generated in different way by a unit of PU. However, the intra-prediction and the inter-prediction are not used together for the PUs that belong to a single CU, and the PUs that belong to a single CU are coded by the same prediction method (i.e., the intra-prediction or the inter-prediction).

A PU is not split in the Quad-tree structure, but is split once in a single CU in a predetermined shape. This will be described by reference to the drawing below.

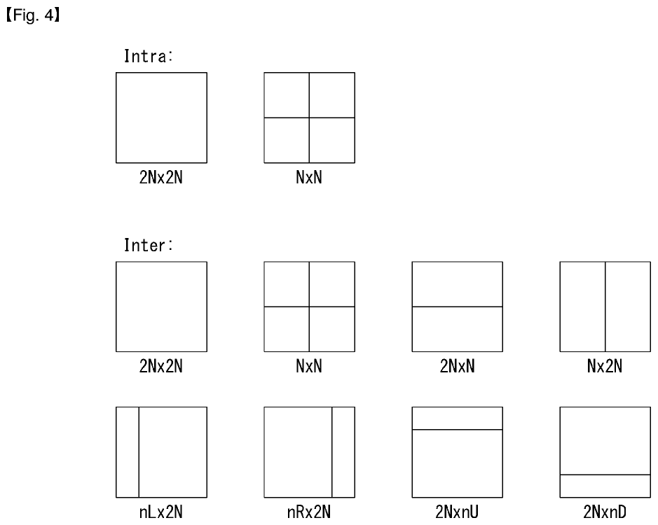

FIG. 4 is a diagram for describing a prediction unit that may be applied to the present invention.

A PU is differently split depending on whether the intra-prediction mode is used or the inter-prediction mode is used as the coding mode of the CU to which the PU belongs.

FIG. 4(a) illustrates a PU if the intra-prediction mode is used, and FIG. 4(b) illustrates a PU if the inter-prediction mode is used.

Referring to FIG. 4(a), assuming that the size of a single CU is 2N×2N (N=4, 8, 16 and 32), the single CU may be split into two types (i.e., 2N×2N or N×N).

In this case, if a single CU is split into the PU of 2N×2N shape, it means that only one PU is present in a single CU.

Meanwhile, if a single CU is split into the PU of N×N shape, a single CU is split into four PUs, and different prediction blocks are generated for each PU unit. However, such PU splitting may be performed only if the size of CB for the luma component of CU is the minimum size (i.e., the case that a CU is an SCU).

Referring to FIG. 4(b), assuming that the size of a single CU is 2N×2N (N=4, 8, 16 and 32), a single CU may be split into eight PU types (i.e., 2N×2N, N×N, 2N×N, N×2N, nL×2N, nR×2N, 2N×nU and 2N×nD)

As in the intra-prediction, the PU split of N×N shape may be performed only if the size of CB for the luma component of CU is the minimum size (i.e., the case that a CU is an SCU).

The inter-prediction supports the PU split in the shape of 2N×N that is split in a horizontal direction and in the shape of N×2N that is split in a vertical direction.

In addition, the inter-prediction supports the PU split in the shape of nL×2N, nR×2N, 2N×nU and 2N×nD, which is an asymmetric motion split (AMP). In this case, ‘n’ means ¼ value of 2N. However, the AMP may not be used if the CU to which the PU is belonged is the CU of minimum size.

In order to encode the input video signal in a single CTU efficiently, the optimal split structure of the coding unit (CU), the prediction unit (PU) and the transform unit (TU) may be determined based on a minimum rate-distortion value through the processing process as follows. For example, as for the optimal CU split process in a 64×64 CTU, the rate-distortion cost may be calculated through the split process from a CU of 64×64 size to a CU of 8×8 size. The detailed process is as follows.

1) The optimal split structure of a PU and TU that generates the minimum rate distortion value is determined by performing inter/intra-prediction, transformation/quantization, dequantization/inverse transformation and entropy encoding on the CU of 64×64 size.

2) The optimal split structure of a PU and TU is determined to split the 64×64 CU into four CUs of 32×32 size and to generate the minimum rate distortion value for each 32×32 CU.

3) The optimal split structure of a PU and TU is determined to further split the 32×32 CU into four CUs of 16×16 size and to generate the minimum rate distortion value for each 16×16 CU.

4) The optimal split structure of a PU and TU is determined to further split the 16×16 CU into four CUs of 8×8 size and to generate the minimum rate distortion value for each 8×8 CU.

5) The optimal split structure of a CU in the 16×16 block is determined by comparing the rate-distortion value of the 16×16 CU obtained in the process 3) with the addition of the rate-distortion value of the four 8×8 CUs obtained in the process 4). This process is also performed for remaining three 16×16 CUs in the same manner.

6) The optimal split structure of CU in the 32×32 block is determined by comparing the rate-distortion value of the 32×32 CU obtained in the process 2) with the addition of the rate-distortion value of the four 16×16 CUs that is obtained in the process 5). This process is also performed for remaining three 32×32 CUs in the same manner.

7) Finally, the optimal split structure of CU in the 64×64 block is determined by comparing the rate-distortion value of the 64×64 CU obtained in the process 1) with the addition of the rate-distortion value of the four 32×32 CUs obtained in the process 6).

In the intra-prediction mode, a prediction mode is selected as a PU unit, and prediction and reconstruction are performed on the selected prediction mode in an actual TU unit.

A TU means a basic unit in which actual prediction and reconstruction are performed. A TU includes a transform block (TB) for a luma component and a TB for two chroma components corresponding to the luma component.

In the example of FIG. 3, as in an example in which one CTU is split in the quad-tree structure to generate a CU, a TU is hierarchically split from one CU to be coded in the quad-tree structure.

TUs split from a CU may be split into smaller and lower TUs because a TU is split in the quad-tree structure. In HEVC, the size of a TU may be determined to be as one of 32×32, 16×16, 8×8 and 4×4.

Referring back to FIG. 3, the root node of a quad-tree is assumed to be related to a CU. The quad-tree is split until a leaf node is reached, and the leaf node corresponds to a TU.

This is described in more detail. A CU corresponds to a root node and has the smallest depth (i.e., depth=0) value. A CU may not be split depending on the characteristics of an input image. In this case, the CU corresponds to a TU.

A CU may be split in a quad-tree form. As a result, lower nodes having a depth 1 (depth=1) are generated. Furthermore, a node (i.e., leaf node) that belongs to the lower nodes having the depth of 1 and that is no longer split corresponds to a TU. For example, in FIG. 3(b), a TU(a), a TU(b) and a TU(j) corresponding to the nodes a, b and j are once split from a CU and have a depth of 1.

At least one of the nodes having the depth of 1 may be split in a quad-tree form again. As a result, lower nodes having a depth 2 (i.e., depth=2) are generated. Furthermore, a node (i.e., leaf node) that belongs to the lower nodes having the depth of 2 and that is no longer split corresponds to a TU. For example, in FIG. 3(b), a TU(c), a TU(h) and a TU(i) corresponding to the node c, h and l have been split twice from the CU and have the depth of 2.

Furthermore, at least one of the nodes having the depth of 2 may be split in a quad-tree form again. As a result, lower nodes having a depth 3 (i.e., depth=3) are generated. Furthermore, a node (i.e., leaf node) that belongs to the lower nodes having the depth of 3 and that is no longer split corresponds to a CU. For example, in FIG. 3(b), a TU(d), a TU(e), a TU(f) and a TU(g) corresponding to the nodes d, e, f and g have been three times split from the CU and have the depth of 3.

A TU having a tree structure may be hierarchically split with predetermined maximum depth information (or maximum level information). Furthermore, each spit TU may have depth information. The depth information may include information about the size of the TU because it indicates the split number and/or degree of the TU.

Information (e.g., a split TU flag “split_transform_flag”) indicating whether a corresponding TU has been split with respect to one TU may be transferred to the decoder. The split information is included in all of TUs other than a TU of a minimum size. For example, if the value of the flag indicating whether a TU has been split is “1”, the corresponding TU is split into four TUs. If the value of the flag indicating whether a TU has been split is “0”, the corresponding TU is no longer split.

Prediction

In order to reconstruct a current processing unit on which decoding is performed, the decoded part of a current picture or other pictures including the current processing unit may be used.

A picture (slice) using only a current picture for reconstruction, that is, on which only intra-prediction is performed, may be called an intra-picture or I picture (slice), a picture (slice) using a maximum of one motion vector and reference index in order to predict each unit may be called a predictive picture or P picture (slice), and a picture (slice) using a maximum of two motion vector and reference indices may be called a bi-predictive picture or B a picture (slice).

Intra-prediction means a prediction method of deriving a current processing block from the data element (e.g., a sample value) of the same decoded picture (or slice). That is, intra-prediction means a method of predicting the pixel value of a current processing block with reference to reconstructed regions within a current picture.

Hereinafter, inter-prediction is described in more detail.

Inter-Prediction (or Inter-Frame Prediction)

Inter-prediction means a prediction method of deriving a current processing block based on the data element (e.g., sample value or motion vector) of a picture other than a current picture. That is, inter-prediction means a method of predicting the pixel value of a current processing block with reference to reconstructed regions within another reconstructed picture other than a current picture.

Inter-prediction (or inter-picture prediction) is a technology for removing redundancy present between pictures and is chiefly performed through motion estimation and motion compensation.

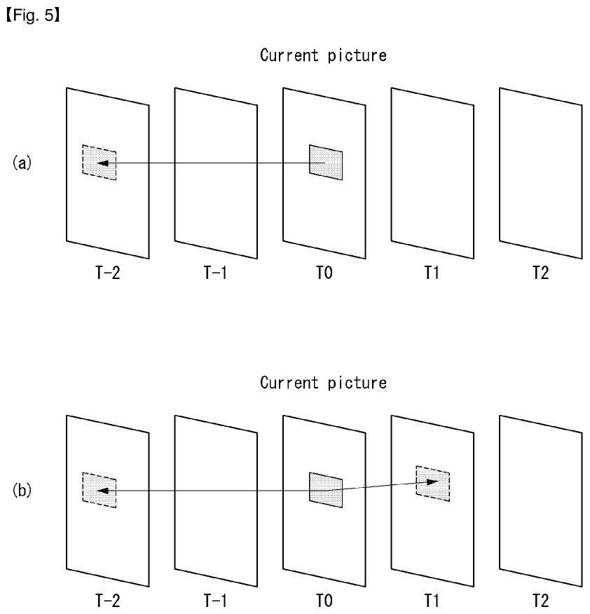

FIG. 5 is an embodiment to which the present invention may be applied and is a diagram illustrating the direction of inter-prediction.

Referring to FIG. 5, inter-prediction may be divided into uni-direction prediction in which only one past picture or future picture is used as a reference picture on a time axis with respect to a single block and bi-directional prediction in which both the past and future pictures are referred at the same time.

Furthermore, the uni-direction prediction may be divided into forward direction prediction in which a single reference picture temporally displayed (or output) prior to a current picture is used and backward direction prediction in which a single reference picture temporally displayed (or output) after a current picture is used.

In the inter-prediction process (i.e., uni-direction or bi-directional prediction), a motion parameter (or information) used to specify which reference region (or reference block) is used in predicting a current block includes an inter-prediction mode (in this case, the inter-prediction mode may indicate a reference direction (i.e., uni-direction or bidirectional) and a reference list (i.e., L0, L1 or bidirectional)), a reference index (or reference picture index or reference list index), and motion vector information. The motion vector information may include a motion vector, motion vector prediction (MVP) or a motion vector difference (MVD). The motion vector difference means a difference between a motion vector and a motion vector predictor.

In the uni-direction prediction, a motion parameter for one-side direction is used. That is, one motion parameter may be necessary to specify a reference region (or reference block).

In the bi-directional prediction, a motion parameter for both directions is used. In the bi-directional prediction method, a maximum of two reference regions may be used. The two reference regions may be present in the same reference picture or may be present in different pictures. That is, in the bi-directional prediction method, a maximum of two motion parameters may be used. Two motion vectors may have the same reference picture index or may have different reference picture indices. In this case, the reference pictures may be displayed temporally prior to a current picture or may be displayed (or output) temporally after a current picture.

The encoder performs motion estimation in which a reference region most similar to a current processing block is searched for in reference pictures in an inter-prediction process. Furthermore, the encoder may provide the decoder with a motion parameter for a reference region.

The encoder/decoder may obtain the reference region of a current processing block using a motion parameter. The reference region is present in a reference picture having a reference index. Furthermore, the pixel value or interpolated value of a reference region specified by a motion vector may be used as the predictor of a current processing block. That is, motion compensation in which an image of a current processing block is predicted from a previously decoded picture is performed using motion information.

In order to reduce the transfer rate related to motion vector information, a method of obtaining a motion vector predictor (mvd) using motion information of previously decoded blocks and transmitting only the corresponding difference (mvd) may be used. That is, the decoder calculates the motion vector predictor of a current processing block using motion information of other decoded blocks and obtains a motion vector value for the current processing block using a difference from the encoder. In obtaining the motion vector predictor, the decoder may obtain various motion vector candidate values using motion information of other already decoded blocks, and may obtain one of the various motion vector candidate values as a motion vector predictor.

Reference Picture Set and Reference Picture List

In order to manage multiple reference pictures, a set of previously decoded pictures are stored in the decoded picture buffer (DPB) for the decoding of the remaining pictures.

A reconstructed picture that belongs to reconstructed pictures stored in the DPB and that is used for inter-prediction is called a reference picture. In other words, a reference picture means a picture including a sample that may be used for inter-prediction in the decoding process of a next picture in a decoding sequence.

A reference picture set (RPS) means a set of reference pictures associated with a picture, and includes all of previously associated pictures in the decoding sequence. A reference picture set may be used for the inter-prediction of an associated picture or a picture following a picture in the decoding sequence. That is, reference pictures retained in the decoded picture buffer (DPB) may be called a reference picture set. The encoder may provide the decoder with a sequence parameter set (SPS) (i.e., a syntax structure having a syntax element) or reference picture set information in each slice header.

A reference picture list means a list of reference pictures used for the inter-prediction of a P picture (or slice) or a B picture (or slice). In this case, the reference picture list may be divided into two reference pictures lists, which may be called a reference picture list 0 (or L0) and a reference picture list 1 (or L1). Furthermore, a reference picture belonging to the reference picture list 0 may be called a reference picture 0 (or L0 reference picture), and a reference picture belonging to the reference picture list 1 may be called a reference picture 1 (or L1 reference picture).

In the decoding process of the P picture (or slice), one reference picture list (i.e., the reference picture list 0). In the decoding process of the B picture (or slice), two reference pictures lists (i.e., the reference picture list 0 and the reference picture list 1) may be used. Information for distinguishing between such reference picture lists for each reference picture may be provided to the decoder through reference picture set information. The decoder adds a reference picture to the reference picture list 0 or the reference picture list 1 based on reference picture set information.

In order to identify any one specific reference picture within a reference picture list, a reference picture index (or reference index) is used.

Fractional Sample Interpolation

A sample of a prediction block for an inter-predicted current processing block is obtained from the sample value of a corresponding reference region within a reference picture identified by a reference picture index. In this case, a corresponding reference region within a reference picture indicates the region of a location indicated by the horizontal component and vertical component of a motion vector. Fractional sample interpolation is used to generate a prediction sample for non-integer sample coordinates except a case where a motion vector has an integer value. For example, a motion vector of ¼ scale of the distance between samples may be supported.

In the case of HEVC, fractional sample interpolation of a luma component applies an 8 tab filter in the traverse direction and longitudinal direction. Furthermore, the fractional sample interpolation of a chroma component applies a 4 tab filter in the traverse direction and the longitudinal direction.

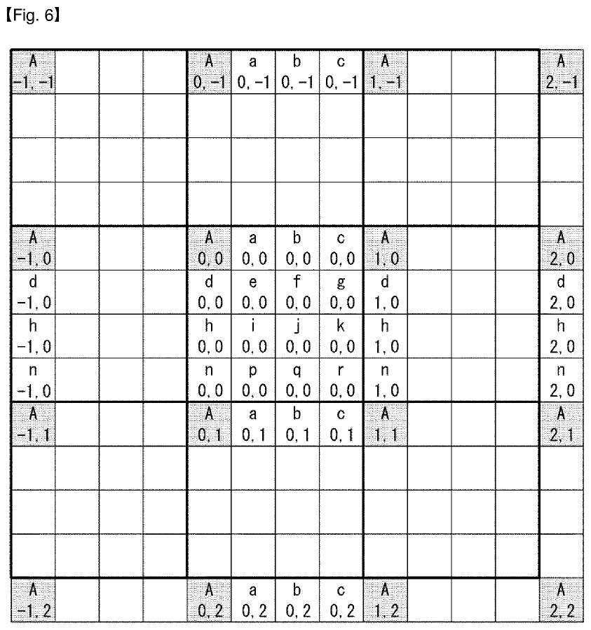

FIG. 6 is an embodiment to which the present invention may be applied and illustrates integers for ¼ sample interpolation and a fraction sample locations.

Referring to FIG. 6, a shadow block in which an upper-case letter (A_i,j) is written indicates an integer sample location, and a block not having a shadow in which a lower-case letter (x_i,j) is written indicates a fraction sample location.

A fraction sample is generated by applying an interpolation filter to an integer sample value in the horizontal direction and the vertical direction. For example, in the case of the horizontal direction, the 8 tab filter may be applied to four integer sample values on the left side and four integer sample values on the right side based on a fraction sample to be generated.

Inter-Prediction Mode

In HEVC, in order to reduce the amount of motion information, a merge mode and advanced motion vector prediction (AMVP) may be used.

1) Merge Mode

The merge mode means a method of deriving a motion parameter (or information) from a spatially or temporally neighbor block.

In the merge mode, a set of available candidates includes spatially neighboring candidates, temporal candidates and generated candidates.

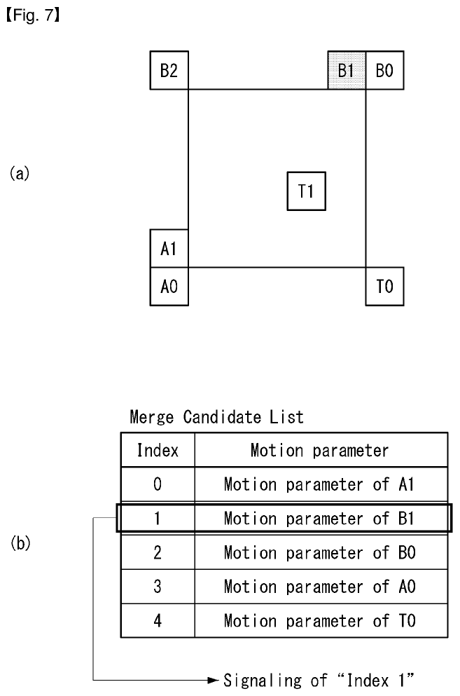

FIG. 7 is an embodiment to which the present invention may be applied and illustrates the location of a spatial candidate.

Referring to FIG. 7(a), whether each spatial candidate block is available depending on the sequence of {A1, B1, B0, A0, B2} is determined. In this case, if a candidate block is not encoded in the intra-prediction mode and motion information is present or if a candidate block is located out of a current picture (or slice), the corresponding candidate block cannot be used.

After the validity of a spatial candidate is determined, a spatial merge candidate may be configured by excluding an unnecessary candidate block from the candidate block of a current processing block. For example, if the candidate block of a current prediction block is a first prediction block within the same coding block, candidate blocks having the same motion information other than a corresponding candidate block may be excluded.

When the spatial merge candidate configuration is completed, a temporal merge candidate configuration process is performed in order of {T0, T1}.

In a temporal candidate configuration, if the right bottom block T0 of a collocated block of a reference picture is available, the corresponding block is configured as a temporal merge candidate. The collocated block means a block present in a location corresponding to a current processing block in a selected reference picture. In contrast, if not, a block T1 located at the center of the collocated block is configured as a temporal merge candidate.

A maximum number of merge candidates may be specified in a slice header. If the number of merge candidates is greater than the maximum number, a spatial candidate and temporal candidate having a smaller number than the maximum number are maintained. If not, the number of additional merge candidates (i.e., combined bi-predictive merging candidates) is generated by combining candidates added so far until the number of candidates becomes the maximum number.

The encoder configures a merge candidate list using the above method, and signals candidate block information, selected in a merge candidate list by performing motion estimation, to the decoder as a merge index (e.g., merge_idx[x0][y0]′). FIG. 7(b) illustrates a case where a B1 block has been selected from the merge candidate list. In this case, an “index 1 (Index 1)” may be signaled to the decoder as a merge index.

The decoder configures a merge candidate list like the encoder, and derives motion information about a current prediction block from motion information of a candidate block corresponding to a merge index from the encoder in the merge candidate list. Furthermore, the decoder generates a prediction block for a current processing block based on the derived motion information (i.e., motion compensation).

2) Advanced Motion Vector Prediction (AMVP) Mode

The AMVP mode means a method of deriving a motion vector prediction value from a neighbor block. Accordingly, a horizontal and vertical motion vector difference (MVD), a reference index and an inter-prediction mode are signaled to the decoder. Horizontal and vertical motion vector values are calculated using the derived motion vector prediction value and a motion vector difference (MVDP) provided by the encoder.

That is, the encoder configures a motion vector predictor candidate list, and signals a motion reference flag (i.e., candidate block information) (e.g., mvp_IX_flag[x0][y0]′), selected in motion vector predictor candidate list by performing motion estimation, to the decoder. The decoder configures a motion vector predictor candidate list like the encoder, and derives the motion vector predictor of a current processing block using motion information of a candidate block indicated by a motion reference flag received from the encoder in the motion vector predictor candidate list. Furthermore, the decoder obtains a motion vector value for the current processing block using the derived motion vector predictor and a motion vector difference transmitted by the encoder. Furthermore, the decoder generates a prediction block for the current processing block based on the derived motion information (i.e., motion compensation).

In the case of the AMVP mode, two spatial motion candidates of the five available candidates in FIG. 7 are selected. The first spatial motion candidate is selected from a {A0, A1} set located on the left side, and the second spatial motion candidate is selected from a {B0, B1, B2} set located at the top. In this case, if the reference index of a neighbor candidate block is not the same as a current prediction block, a motion vector is scaled.

If the number of candidates selected as a result of search for spatial motion candidates is 2, a candidate configuration is terminated. If the number of selected candidates is less than 2, a temporal motion candidate is added.

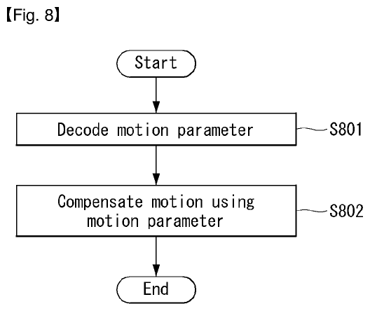

FIG. 8 is an embodiment to which the present invention is applied and is a diagram illustrating an inter-prediction method.

Referring to FIG. 8, the decoder (in particular, the inter-prediction unit 261 of the decoder in FIG. 2) decodes a motion parameter for a processing block (e.g., a prediction unit) (S801).

For example, if the merge mode has been applied to the processing block, the decoder may decode a merge index signaled by the encoder. Furthermore, the motion parameter of the current processing block may be derived from the motion parameter of a candidate block indicated by the merge index.

Furthermore, if the AMVP mode has been applied to the processing block, the decoder may decode a horizontal and vertical motion vector difference (MVD), a reference index and an inter-prediction mode signaled by the encoder. Furthermore, the decoder may derive a motion vector predictor from the motion parameter of a candidate block indicated by a motion reference flag, and may derive the motion vector value of a current processing block using the motion vector predictor and the received motion vector difference.

The decoder performs motion compensation on a prediction unit using the decoded motion parameter (or information) (S802).

That is, the encoder/decoder perform motion compensation in which an image of a current unit is predicted from a previously decoded picture using the decoded motion parameter.

### Embodiment 1

In an embodiment of the present invention, in the structure in which a coding unit and a transform unit are distinguished, an encoder may transmit syntax in a unit of coding unit to a decoder.

In the structure in which a coding unit and a transform unit are hierarchically divided, a coding unit may be partitioned into a transform unit with a quad-tree structure in order to perform a transform. In this case, the encoder may transmit syntax indicating whether there is a residual signal to a unit of coding unit which is a high level, and transmit syntax indicating whether there is a residual signal to the decoder again for each component of a unit of transform in the quad-tree partition process.

Table 1 below represents encoding unit syntax.

TABLE 1

| coding_unit( x0, y0, log2CbSize ) { | Descriptor |
|---|---|
| if( transquant_bypass_enabled_flag ) | |
| cu_transquant_bypass_flag | ae(v) |
| if( slice_type != l ) | |
| cu_skip_flag[ x0 ][ y0 ] | ae(v) |
| nCbS = ( 1 << log2CbSize ) | |
| if( cu_skip_flag[ x0 ][ y0 ] ) | |
| prediction_unit( x0, y0, nCbS, nCbS) | |
| else { | |
| ...(omit) | |
| ...(omit) | |
| if( !pcm_flag[ x0 ][ y0 ] ) { | |
| if( CuPredMode[ x0 ][ y0 ] != MODE_INTRA && | |
| !( PartMode = = PART_2Nx2N && | |
| merge_flag[ x0 ][ y0 ] ) ) | |
| rqt_root_cbf | ae(v) |
| if( rqt_root_cbf ) { | |
| MaxTrafoDepth = ( CuPredMode[ x0 ][ y0 ] = = | |
| MODE_INTRA ? | |
| ( max_transform_hierarchy_depth_intra + | |
| IntraSplitFlag ) : | |
| max_transform_hierarchy_dept_ inter ) | |
| transform_tree( x0, y0, x0, y0, log2CbSize, 0, 0 ) | |
| } | |
| } | |
| } | |
| } | |

Referring to Table 1, a decoding process for a coding unit is described.
if (transquant_bypass_enabled_flag): When a decoding process ‘coding_unit(x0, y0, log 2CbSize)’ for a coding unit (or coding block) is called (here, x0, y0 represents a relative position of a top-left sample of a current coding unit from a top-left sample of a current picture, and log 2CbSize represents a value in which log 2 is taken in a size of the current coding unit. The decoder determines whether there exist ‘cu_transquant_bypass_flag’ first.

Here, the case that ‘transquant_bypass_enabled_flag’ value is 1 means that ‘cu_transquant_bypass_flag’ is existed.
cu_transquant_bypass_flag: In the case that ‘cu_transquant_bypass_flag’ is existed, the decoder parses ‘cu_transquant_bypass_flag’.

In the case that ‘cu_transquant_bypass_flag’ value is 1, scaling and transform process and in-loop filter process may be skipped.
if (slice_type !=I): The decoder determines whether a slice type of the current coding unit is Islice type or not.
cu_skip_flag[x0][y0]: In the case that the slice type of the current coding unit is not Islice type, the decoder parses ‘cu_skip_flag[x0][y0]’.

Here, ‘cu_skip_flag[x0][y0]’ may indicate whether the current coding unit is existed in the skip mode. That is, in the case that ‘cu_skip_flag[x0][y0]’ is 1, an additional syntax element except the index information for merge is not parsed in the coding unit syntax.
nCbS=(1«log 2CbSize): Variable nCbs is set as 1«log 2CbSize′ value.

Here, nCbs represents a size of the current block.
if (cu_skip_flag[x0][y0]): The decoder determines whether the current coding unit is in the skip mode.
prediction_unit(x0, y0, nCbS, nCbS): In the case that the current coding unit is in the skip mode, the decoding process ‘prediction_unit(x0, y0, nCbS, nCbS)’ for a prediction unit (or prediction block) is called, and an additional syntax element is not signaled.
if (!pcm_flag[x0][y0]): The decoder determines whether the current coding unit is in the pcm mode or not.

Here, the case that ‘pcm_flag[x0][y0]’ value is 1 means that the coding unit of a luma component includes ‘pcm_sample( )’ syntax and does not include ‘transform_tree( )’ syntax in the coordinate (x0, y0). The case that ‘pcm_flag[x0][y0]’ value is 0 means that the coding unit of a luma component does not include ‘pcm_sample( )’ syntax in the coordinate (x0, y0).
if (CuPredMode[x0][y0] !=MODE_INTRA && !(PartMode==PART 2N×2N && merge_flag[x0][y0])): In the case that the current coding unit is not in the pcm mode, the decoder determines whether a prediction mode of the current coding unit is an intra mode or not, and whether the current coding unit is in the merge mode and of which partition mode is PART_2N×2N or not simultaneously.
rqt_root_cbf: In the case that a prediction mode of the current coding unit is not an intra mode, and in the case that the current coding unit is in the merge mode and of which partition mode is not PART_2N×2N simultaneously, the decoder parses rqt_root_cbf.
if(rqt_root_cbf): The decoder determines whether rqt_root_cbf syntax element value is 1, that is, whether to call transform tree (transform_tree( ) syntax.
MaxTrafoDepth=(CuPredMode[x0][y0]==MODE_INTRA ? (max_transform_hierarchy_depth_intra+IntraSplitFlag): max_transform_hierarchy_depth_inter): In the case that the current prediction mode is an intra mode as variable MaxTrafoDepth, the decoder set max_transform_hierarchy_depth_intra+IntraSplitFlag value, and in the case that the current prediction mode is an inter mode, the decoder set max_transform_hierarchy_depth_inter value.

Here, max_transform_hierarchy_depth_intra value indicates a maximum layer depth for a transform block of the current coding block in an intra prediction mode, and max_transform_hierarchy_depth_inter value indicates a maximum layer depth for a transform block of the current coding block in an inter prediction mode. The case that IntraSplitFlag value is 0 indicates that a partition mode is PART_2N×2N in the intra mode, and the case that IntraSplitFlag value is 1 indicates that a partition mode is PART_N×N.

At this time, rqt_root_cbf may be defined as in Table 2 below.

TABLE 2
rqt_root_cbf equal to 1 specifies that the transform_tree( ) syntax
structure is present for the current coding unit. rqt_root_cbf equal to 0
specifies that the transform_tree( ) syntax structure is not present for the
current coding unit. When rqt_root_cbf is not present, its value is
inferred to be equal to 1.

Referring to Table 2, the case that rqt_root_cbf value is 1 means that a transform tree (transform_tree( )) syntax for the current coding unit is existed, and the case that rqt_root_cbf value is 0 means that a transform tree syntax for the current coding unit is not existed. Further, in the case that rqt_root_cbf value is not existed, it may be regarded that the value is 1. That is, rqt_root_cbf is a syntax element indicating whether a residual signal is existed, and in the case that a specific condition is satisfied, it may be transmitted with a unit of coding unit.

In addition, the specific condition for rqt_root_cbf being transmitted is as represented in Table 3 below. That is, rqt_root_cbf is a coding block which is predicted through a prediction between pictures, and in the case that the condition as represented is Table 3 is satisfied, rqt_root_cbf is signaled from an encoder to a decoder.

TABLE 3

| | Partion | Merge | |
|---|---|---|---|
| Condition | Size | on/off | Note |
| 1 | !(2Nx2N) | On | Case that it is Merge, but not 2Nx2N |
| 2 | !(2Nx2N) | Off | Case that it is neither Merge nor |
| | | | 2Nx2N |
| 3 | 2Nx2N | Off | Case that it is 2Nx2N, but not merge |

Table 4 below represents transform tree unit syntax.

TABLE 4

| transform_tree( x0, y0, xBase, yBase, log2TrafoSize, trafoDepth, blkldx | |
|---|---|
| ) { | Descriptor |
| if( log2TrafoSize <= Log2MaxTrafoSize && | |
| log2TrafoSize > Log2MinTrafoSize && | |
| trafoDepth < MaxTrafoDepth && !( IntraSplitFlag && | |
| ( trafoDepth = = 0 ) ) ) | |
| split_transform_flag[ x0 ][ y0 ][ trafoDepth ] | ae(v) |
| if( log2TrafoSize > 2) { | |
| if( trafoDepth = = 0 \| \| | |
| cbf_cb[ xBase ][ yBase ][ trafoDepth − 1 ] ) | |
| cbf_cb[ x0 ][ y0 ][ trafoDepth ] | ae(v) |
| if( trafoDepth = = 0 \| \| | |
| cbf_cr[ xBase ][ yBase ][ trafoDepth − 1 ]) | |
| cbf_ cr[ x0 ][ y0 ][ trafoDepth ] | ae(v) |
| } | |
| if( split_transform_flag[ x0 ][ y0 ][ trafoDepth ] ) { | |
| x1 = x0 + ( 1 << ( log2TrafoSize − 1 ) ) | |
| y1 = y0 + ( 1 << ( log2TrafoSize − 1 ) ) | |
| transform_tree( x0, y0, x0, y0, log2TrafoSize − 1, trafoDepth + 1, 0 ) | |
| transform_tree( x1, y0, x0, y0, log2TrafoSize − 1, trafoDepth + 1, 1 ) | |
| transform_tree( x0, y1, x0, y0, log2TrafoSize − 1, trafoDepth + 1, 2 ) | |
| transform_tree( x1, y1, x0, y0, log2TrafoSize − 1, trafoDepth + 1, 3 ) | |
| } else { | |
| if( CuPredMode[ x0 ][ y0 ] = = MODE_INTRA \| \| | |
| trafoDepth != 0 \| \| | |
| cbf_cb[ x0 ][ y0 ][ trafoDepth ] \| \| | |
| cbf_cr[ x0 ][ y0 ][ trafoDepth ] ) | |
| cbf_luma[ x0 ][ y0 ][ trafoDepth ] | ae(v) |
| transform_unit( x0, y0, xBase, yBase, log2TrafoSize, trafoDepth, blkld | |
| x ) | |
| } | |
| } | |

Referring to Table 4, a decoder may partition a current transform unit in a quad-tree format.

The decoder parses a split flag (split_transform_flag) in the case that a size (log 2TrafoSize) of the current transform unit is equal to or smaller than a maximum size (Log 2MaxTrafoSize), greater than a minimum size (Log 2MinTrafoSize) of the transform unit, and a partition depth (trafoDepth) of the current transform unit is smaller than a maximum partition depth (MaxTrafoDepth).

In addition, in the case that the current transform unit is greater than 4λ4, the decoder parses the syntax element cbf_cb, cbf_cr indicating whether a residual signal of a chroma component is existed.

Furthermore, when the split flag value is 1, the decoder partitions the current transform unit into a quad-tree format, and calls a transform tree function in a unit of each of the partitioned transform unit.

When the split flag value is 0, the decoder parses the syntax element cbf_luma indicating whether a residual signal of a luma component is existed, in the case that a partition depth of the current transform unit is 0 or a value of cbf_cb or cbf_cr is 1.

In addition, the decoder calls a transform unit decoding function (transform_unit).

Table 5 below represents definitions of cbf_cr, cbf_cb and cbf_luma syntax elements.

TABLE 5
cbf_luma[ x0 ][ y0 ][ trafoDepth ] equal to 1 specifies that the luma
transform block contains one or more transform coefficient levels not
equal to 0. The array indices x0, y0 specify the location ( x0, y0 ) of the
top-left luma sample of the considered transform block relative to the
top-left luma sample of the picture. The array index trafoDepth specifies
the current subdivision level of a coding block into blocks for the
purpose of transform coding. trafoDepth is equal to 0 for blocks that
correspond to coding blocks.
When cbf_luma[ x0 ][ y0 ][ trafoDepth ] is not present, it is inferred to
be equal to 1.
cbf_cb[ x0 ][ y0 ][ trafoDepth ] equal to 1 specifies that the Cb transform
block contains one or more transform coefficient levels not equal to 0.
The array indices x0, y0 specify the top-left location ( x0, y0 ) of the
considered transform unit. The array index trafoDepth specifies the
current subdivision level of a coding block into blocks for the purpose of
transform coding. trafoDepth is equal to 0 for blocks that correspond to
coding blocks.
When cbf_cb[ x0 ][ y0 ][ trafoDepth ] is not present, the value of
cbf_cb[ x0 ][ y0 ][ trafoDepth ] is inferred as follows:
If trafoDepth is greater than 0 and log2TrafoSize is equal to 2,
cbf_cb[ x0 ][ y0 ][ trafoDepth ] is inferred to be equal to
cbf_cb[ xBase ][ yBase ][ trafoDepth − 1 ]
Otherwise, cbf_cb[ x0 ][ y0 ][ trafoDepth ] is inferred to be equal to 0.
cbf_cr[ x0 ][ y0 ][ trafoDepth ] equal to 1 specifies that the Cr transform
block contains one or more transform coefficient levels not equal to 0.
The array indices x0, y0 specify the top-left location ( x0, y0 ) of the
considered transform unit. The array index trafoDepth specifies the
current subdivision level of a coding block into blocks for the purpose of
transform coding. trafoDepth is equal to 0 for blocks that correspond to
coding blocks.
When cbf_cr[ x0 ][ y0 ][ trafoDepth ] is not present, the value of
cbf_cr[ x0 ][ y0 ][ trafoDepth ] is inferred as follows:
If trafoDepth is greater than 0 and log2TrafoSize is equal to 2,
cbf_cr[ x0 ][ y0 ][ trafoDepth ] is inferred to be equal to
cbf_cr[ xBase ][ yBase ][ trafoDepth − 1 ]
Otherwise, cbf_cr[ x0 ][ y0 ][ trafoDepth ] is inferred to be equal to 0.

Referring to Table 4 and Table 5, when rqt_root_cbf is 1, cbf syntax indicating whether a residual signal of each component (i.e., luma and chroma (Cb, Cr)) is present and syntax of the transform unit are encoded/decoded with a particular condition.

As described above, in the case that a partition depth of the transform unit is not 0 or a value of residual signal presence syntax (i.e., cbf_cr or cbf_cb) of a chroma component is 1, the syntax indicating whether a residual signal of a luma component, cbf_luma, may be decoded. In addition, in the case that the current transform unit is 8×8 or more and a partition depth of the transform unit is 0 or cbf in a depth of the previous transform unit is 1, cbf_cr and cbf_cb may be decoded. This is described with reference to the drawing below.

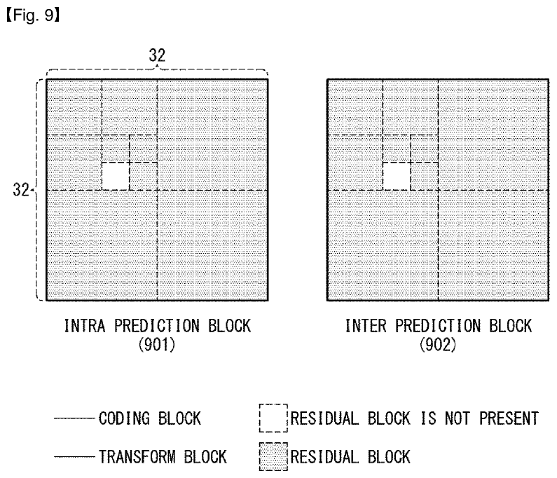

FIG. 9 is a diagram for describing a method of decoding a syntax indicating whether a residual signal is present as an embodiment to which the present invention may be applied.

Referring to FIG. 9, it is assumed that current coding blocks 901 and 902 have a size of 32×32.

The current coding blocks 901 and 902 encoded with an intra prediction mode or an inter prediction mode may be partitioned in a quad-tree scheme in order to perform a transform. Transform/inverse transform is performed in a unit of transform unit which is partitioned from the coding blocks 901 and 902.

As described above, in the case that the current block is the block 901 which is encoded with an intra prediction mode, rqt_root_cbf is not encoded/decoded. However, in the case that the current block is the block 902 which is encoded with an inter prediction mode, encoding/decoding of rqt_root_cbf is performed.

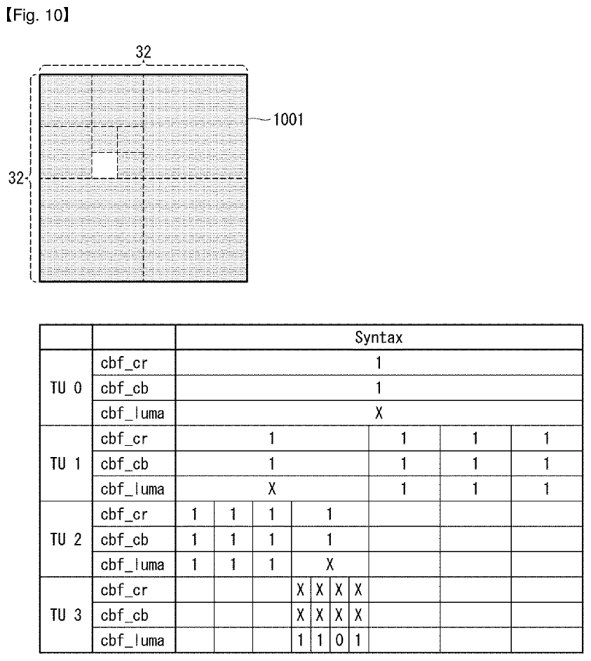

FIG. 10 is a diagram for describing a syntax signaled for representing whether a residual signal is present according to a partition depth of a transform unit as an embodiment to which the present invention may be applied.

Referring to FIG. 10, cbf information of a current block 1001 may be transmitted in a unit of transform unit. At this time, cbf of a chroma component may be transmitted in a higher depth indicating whether a residual signal is present in a block included in a transform unit of the corresponding depth in a depth (or level) of each transform unit. However, a luma component may be transmitted through cbf on whether a residual signal is present in a transform unit depth in which an actual transform is performed.

For the luma component, since a probability of occurrence of a residual signal is relatively higher than the chroma component, cbf is transmitted in the depth in which actual transform is performed, and accordingly, the size of bits may be saved.

### Embodiment 2

In an embodiment of the present invention, in the block partition structure in which a coding unit and a transform unit are the same, as in embodiment 1 described above, an encoder may transmit a syntax indicating a residual signal is present in a unit of coding unit to a decoder.

In Quadtree plus Binarytree (QTBT) structure, a unit in which a prediction encoding is performed and a unit in which a transform encoding is performed may be determined in the same way. QTBT is referred to as a partition structure of a coding block in which a quadtree structure and a binarytree structure are combined. Particularly, in QTBT structure, a picture is coded with a unit of CTU, and a CTU is partitioned in a quadtree format first, and a leaf node of a quadtree is further partitioned in a binarytree format.

In this embodiment, it is proposed a condition of encoding/decoding and a method of encoding/decoding of cbf indicating whether a residual signal is present in the QTBT structure. An encoder may transmit rqt_root_cbf indicating whether a residual signal is present in a coding unit level.

Table 6 below represents a coding unit syntax which is applicable in the QTBT structure.

TABLE 6

| coding_unit( x0, y0, log2CbSize ) { | Descriptor |
|---|---|
| if( transquant_bypass_enabled_flag ) | |
| cu_transquant_bypass_flag | ae(v) |
| if( slice_type != l ) | |
| cu_skip_flag[ x0 ][ y0 ] | ae(v) |
| nCbS = ( 1 << log2CbSize ) | |
| if( cu_skip_flag[ x0 ][ y0 ] ) | |
| prediction unit( x0, y0, nCbS, nCbS ) | |
| else { | |
| ...(omit) | |
| ...(omit) | |
| if( !pcm_flag[ x0 ][ y0 ] ) { | |
| if( CuPredMode[ x0 ][ y0 ] != MODE_INTRA && | |
| ! merge_flag[ x0 ][ y0 ] ) | |
| rqt_root_cbf | ae(v) |
| if(rqt_root_cbf){ | |
| if(textType == CHROMA) \|\| slice_type != l )){ | |
| transform_tree( x0, y0, x0, y0 ,COMPONENT_CB) | |
| transform_tree( x0, y0, x0, y0 ,COMPONENT_CR) | |
| } | |
| if(textType==LUMA){ | |
| transform_tree( x0, y0, x0, y0 ,COMPONENT_LUMA) | |
| } | |
| } | |
| } | |
| } | |
| } | |
| } | |

Referring to Table 6, in the decoding process for a coding unit, the steps before the step of parting rqt_root_cbf by a decoder may be performed in the same method represented in Table 1 above.
if (CuPredMode[x0][y0] !=MODE_INTRA && !merge_flag[x0][y0])): In the case that the current coding unit is not in the pcm mode, the decoder determines whether a prediction mode of the current coding unit is an intra mode or not, and whether the current coding unit is in the merge mode and of which partition mode is PART 2N×2N or not simultaneously.
rqt_root_cbf: In the case that a prediction mode of the current coding unit is not an intra mode, and in the case that the current coding unit is in the merge mode and of which partition mode is not PART_2N×2N simultaneously, the decoder parses rqt_root_cbf.
if(rqt_root_cbf): The decoder determines whether rqt_root_cbf syntax element value is 1, that is, whether to call transform tree (transform_tree( ) syntax.
if(textType==CHROMA)∥slice_type !=I): The decoder determines whether the current component is a chroma component or a slice type is I slice or not.

In the case that the current component is a chroma component or not I slice, the decoder calls a transform tree function (transform_tree( )) of each of CB and CR.
if(textType==LUMA): The decoder determines whether the current component is a luma component.

In the case that the current component is a luma component, the decoder calls a transform tree function of a luma component.

In the QTBT structure, a unit of coding and a unit of prediction are not distinguished, and there may be a coding block (e.g., coding block of 2N×N or 2N×¼N size) of non-square.

Accordingly, different from the condition in embodiment 1 above, regardless of the fact that the partition mode of the current coding unit is PART 2N×2N, the decoder may decode rqt_root_cbf syntax in the case that a block encoded with an inter prediction is not in the merge mode.

Table 7 below represents a transform tree unit syntax which is applicable in the QTBT structure.

TABLE 7

| transform_tree( x0, y0, xBase, yBase,compID) { | Descriptor |
|---|---|
| if(compID != COMPONENT_LUMA) | |
| cbf[compID] | ae(v) |
| if((compID == COMPONENT_LUMA && CuPredMode[ x0 ][ y0 ] == | |
| MODE_INTRA) \|\| (( cbf[COMPONENT_CB] \|\| cbf[COMPONENT_CR]) | |
| && CuPredMode[ x0 ][ y0 ]== MODE_INTER ) | |
| cbf[COMPONENT_LUMA] | ae(v) |
| transform_unit( x0, y0, xBase, yBase) | |
| } | |
| } | |

Referring to Table 7, first, a decoder parses cbf of a chroma component of a current transform unit. In addition, in the case that the current prediction mode is an intra mode or the current prediction mode is an inter mode and cbf value of CB or CR component is 1, the decoder parses cbf of a luma component. Later, the decoder calls a decoding process (transform_unit( )) for a transform unit.

The decoder does not partition a coding unit additionally, but performs a transform with a block of the same size as the coding unit. In addition, the decoder may partition the luma component and the chroma component in I-slice with different structures.

### Embodiment 3

In an embodiment of the present invention, it is proposed a method of designing Coded Bit Flag (CBF) syntax indicating whether a residual signal is present in accordance with the QTBT structure.

In this embodiment, in the partition structure (or compression technique) like the QTBT in which a coding unit, a prediction unit and a transform unit are not distinguished, an encoder may signal whether a residual signal is present to a decoder for each component without transmitting a separate syntax in a higher level.

In embodiment 1 described above, in the case that a current coding unit is not skip mode but a merge mode, since a residual signal is necessarily existed in the current coding unit, it is not required to decode rqt_root_cbf. On the other hand, in the case that PU partition like N×2N, 2N×N, and so on is performed in a current block or the current block is not in the merge mode, decoding of rqt_root_cbf is performed. That is, in the case of AMVP mode, not the merge mode, rqt_root_cbf is regarded as 0 although there is loss that may occur in the case that a residual signal is not present, an improvement of encoding efficiency is available according to bit saving.

However, in the structure in which an encoding is performed in the same unit of block without distinguishing of a coding unit and a transform unit, according to the method described in embodiment 2 above, since a partition for a transform unit is not performed, without regard to whether the merge mode is applied, cbf information for each component may be saved only in the case that rqt_root_cbf value is 1, there is a problem that the syntax transmitted in a higher level such as rqt_root_cbf is not efficiently used. This is described with reference to the drawing below in detail.

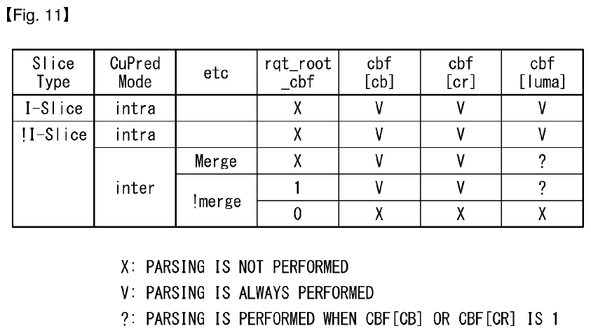

FIG. 11 is a diagram for describing the problem occurred as a syntax indicating whether a residual signal is present is transmitted in a higher level as an embodiment to which the present invention may be applied.

Referring to FIG. 11, it is assumed the case that a syntax indicating whether a residual signal is present is transmitted according to the method described in embodiment 2 above.

In the method described in embodiment 2 above, the decoder parses rqt_root_cbf only in the case of the inter prediction mode and not the merge mode, and does not parse rqt_root_cbf in the remaining cases. Furthermore, in the case of being encoded in the inter prediction mode, the decoder parses cbf[luma] when cbf[cb] or cbf[cr] value is 1. In other words, the decoder parses a residual signal of a luma component in the case that a residual signal of a chroma component is present. The case that cbf of the chroma component is parsed corresponds to the case that it is not skip mode in the inter prediction mode already, and in the case of the merge mode, not the skip mode, since a residual signal of the chroma component is necessarily present when a residual signal of the chroma component is not existed, in this case, cbf of the luma component is not parsed.

Meanwhile, when the merge mode is not applied, it is highly probable that a residual signal is generated in AMVP mode. Nevertheless, in the case of the AMVP mode, when rqt_root_cbf is coded, maximum 4 bits needs to be encoded (or allocated) for cbf. In the case that rqt_root_cbf is coded with 0, since only rqt_root_cbf is coded, 3 bits for cbf coding of remaining 3 cbfs may be caved, but there is a problem that it is inefficient since an occurrence frequency is very low probabilistically or statistically.

Accordingly, in order to solve such a problem, the present invention proposes a method of performing cbf coding for each component by removing rqt_root_cbf syntax by considering an occurrence probability of residual signal in the QTBT structure and the AMVP mode.

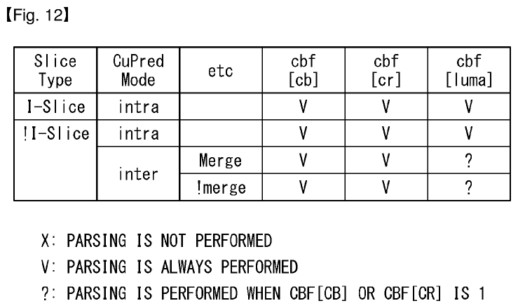

FIG. 12 is a diagram for describing a method of transmitting a syntax indicating whether a residual signal is present directly for each component as an embodiment to which the present invention may be applied.

Referring to FIG. 12, an encoder does not transmit a syntax indicating whether a residual signal is present in a higher level, but it is signaled to a decoder whether a residual signal is present immediately for each component of a current block.

In other words, by removing rqt_root_cbf syntax in FIG. 11 above, the encoder may signal whether a residual signal is present with maximum 3 bits only in the case of not the merge mode.

According to this embodiment, the syntax of Table 6 described above may be modified as represented in Table 8 below.

TABLE 8

| coding_unit( x0, y0, log2CbSize ) { | Descriptor |
|---|---|
| if( transquant_bypass_enabled_flag ) | |
| cu_transquant_bypass_flag | ae(v) |
| if( slice_type != l ) | |
| cu_skip_flag[ x0 ][ y0 ] | ae(v) |
| nCbS = ( 1 << log2CbSize ) | |
| if( cu_skip_flag[ x0 ][ y0 ] ) | |
| prediction_unit( x0, y0, nCbS, nCbS ) | |
| else { | |
| ...(omit) | |
| ...(omit) | |
| if( !pcm_flag[ x0 ][ y0 ] ) { | |
| if(textType == CHROMA) \|\| slice_type != l ){ | |
| transform_tree( x0, y0, x0, y0 ,COMPONENT_CB) | |
| transform_tree( x0, y0, x0, y0 ,COMPONENT_CR) | |
| } | |
| if(textType==LUMA){ | |
| transform_tree( x0, y0, x0, y0 ,COMPONENT_LUMA) | |
| } | |
| } | |
| } | |
| } | |
| } | |

Referring to Table 8, in the case that a current coding unit is not in the pcm mode, a decoder determines whether the current component is a chroma component or a slice type is I slice or not. In the case that the current component is the chroma component or not I slice, the decoder calls a transform tree function (transform tree( )) of each of CB and CR.

In addition, the decoder determines whether the current component is a luma component, and in the case that the current component is the luma component, the decoder calls a transform tree function of the luma component.

That is, the decoder does not parse rqt_root_cbf separately, but calls the transform tree function for performing a transform of the chroma component and the luma component. Later, in the transform tree function, in the same way as described in Table 7 above, the decoder may parse cbf of the chroma component, and in the case that the current prediction mode is an inter mode and cbf value of CB or CR component is 1, the decoder may parse cbf of the luma component.

### Embodiment 4

In an embodiment of the present invention, an encoder/decoder may apply a skip mode in an AMVP mode. That is, in the case that a current block is in the AMVP mode and a residual signal is not present, the encoder may transmit AMVP skip flag to the decoder.

In embodiment 3 described above, the encoder does not transmit rqt_root_cbf in the AMVP node, not the merge mode. Owing to this, cbf is transmitted for each component. In this case, in the case that cbfs of all components have a value of 0, the corresponding block which is encoded with AMVP is a block in which a residual signal is not present.

In order to represent this efficiently, by using the AMVP skip flag, in the case of the AMVP mode, the encoder may signal a flag indicating whether it is in the skip mode to the decoder.

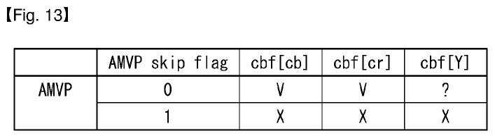

FIG. 13 is a diagram for describing syntax for supporting skip in an AMVP mode as an embodiment to which the present invention may be applied.

Referring to FIG. 13, in the AMVP mode, signaling on whether a residual signal of each component is present may be determined according to a value of the AMVP skip flag.

In the case that the AMVP skip flag is 1, an encoder may not signal cbf indicating whether a residual signal of each component is present to a decoder. On the other hand, in the case that the AMVP skip flag is 0, the encoder may transmit cbf for a chroma component to the decoder, and determine whether to transmit cbf of a luma component according to cbf value of the chroma component. In this case, in the case that a residual signal of the chroma component is not present, the encoder may not signal the presence of the residual signal of the luma component to the decoder.

The embodiments described above may be independently applied, or one or more embodiments may be applied in a combined manner.

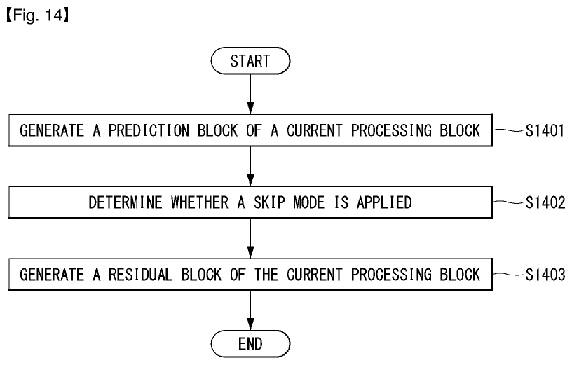

FIG. 14 is a diagram for describing a method for decoding an image according to an embodiment of the present invention.

Referring to FIG. 14, the processing method of an image according to this embodiment is described for a decoder mainly for the convenience of description, but the processing method of an image may be applied to an encoder or a decoder in the same way.

A decoder generates a prediction block of a current processing block by using a prediction mode of the current processing block (step, S1401).

Here, the current processing block indicates a block in which a leaf node block partitioned into a quadtree structure from a basic unit partitioning a picture is partitioned into a binary tree structure.

The decoder determines whether a skip mode is applied to the current processing block (step, S1402).

When the skip mode is not applied for the current processing block, the decoder generates a residual block of the current processing block (step, S1403).

Step S1403 may include decoding a syntax element indicating whether a residual signal is existed in a chroma component of the current processing block.

In addition, when a residual signal is existed in the chroma component, step S1403 may include decoding a syntax element indicating whether a residual signal is existed in a luma component of the current processing block.

In the case that a residual signal is not existed in the chroma component, it may be estimated that the residual signal is existed in the luma component.

In addition, in the case that a prediction mode of the current processing block is an inter-prediction mode, the decoder determines whether a merge mode is applied to the current processing block, and in the case that the merge mode is not applied to the current processing block, that is, an AMVP mode is applied to the current processing block, the decoder may decode a reference picture index of the current processing block and a motion vector differential value.

In addition, in the case that the merge mode is not applied to the current processing block, step S1403 may include decoding an Advanced Motion Vector Prediction (AMVP) skip flag indicating that a decoding syntax of a residual block is not existed in an AMVP mode.

Furthermore, in the case that the AMVP flag indicates 0 and the residual signal is not existed in the chroma component, step S1403 may include decoding a syntax element indicating whether a residual signal is existed in the luma component of the current processing block.

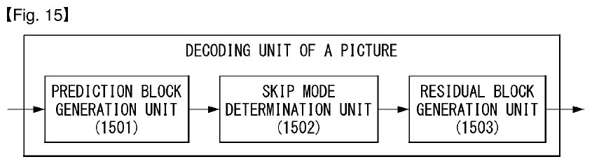

FIG. 15 is a diagram illustrating a decoding apparatus of a picture according to an embodiment of the present invention in detail.

Referring to FIG. 15, the decoding apparatus of a picture is shown as a single block, but the decoding unit of a picture may be implemented as an element which is included in an encoder and/or a decoder.

Referring to FIG. 15, the decoding apparatus of a picture implements the function, the process and/or the method proposed in FIG. 5 to FIG. 14 above. Particularly, the decoding unit of a picture may include a prediction block generation unit 1501, a skip mode determination unit 1502 and a residual block generation unit 1503.

The prediction block generation unit 1501 generates a prediction block of a current processing block by using a prediction mode of the current processing block.

Here, the current processing block indicates a block in which a leaf node block partitioned into a quadtree structure from a basic unit partitioning a picture is partitioned into a binary tree structure.

The skip mode determination unit 1502 determines whether a skip mode is applied to the current processing block.

When the skip mode is not applied for the current processing block, the residual block generation unit 1503 generates a residual block of the current processing block.

The residual block generation unit 1503 may decode a syntax element indicating whether a residual signal is existed in a chroma component of the current processing block.

In addition, when a residual signal is existed in the chroma component, the residual block generation unit 1503 may decode a syntax element indicating whether a residual signal is existed in a luma component of the current processing block.

In the case that a residual signal is not existed in the chroma component, it may be estimated that the residual signal is existed in the luma component.

In addition, in the case that a prediction mode of the current processing block is an inter-prediction mode, the residual block generation unit 1503 determines whether a merge mode is applied to the current processing block, and in the case that the merge mode is not applied to the current processing block, that is, an AMVP mode is applied to the current processing block, the residual block generation unit 1503 may decode a reference picture index of the current processing block and a motion vector differential value.

In addition, in the case that the merge mode is not applied to the current processing block, the residual block generation unit 1503 may decode an Advanced Motion Vector Prediction (AMVP) skip flag indicating that a decoding syntax of a residual block is not existed in an AMVP mode.

Furthermore, in the case that the AMVP flag indicates 0 and the residual signal is not existed in the chroma component, the residual block generation unit 1503 may decode a syntax element indicating whether a residual signal is existed in the luma component of the current processing block.

In the aforementioned embodiments, the elements and characteristics of the present invention have been combined in specific forms. Each of the elements or characteristics may be considered to be optional unless otherwise described explicitly. Each of the elements or characteristics may be implemented in such a way as to be not combined with other elements or characteristics. Furthermore, some of the elements and/or the characteristics may be combined to form an embodiment of the present invention. The order of the operations described in connection with the embodiments of the present invention may be changed. Some of the elements or characteristics of an embodiment may be included in another embodiment or may be replaced with corresponding elements or characteristics of another embodiment. It is evident that an embodiment may be configured by combining claims not having an explicit citation relation in the claims or may be included as a new claim by amendments after filing an application.

The embodiment of the present invention may be implemented by various means, for example, hardware, firmware, software or a combination of them. In the case of implementations by hardware, an embodiment of the present invention may be implemented using one or more application-specific integrated circuits (ASICs), digital signal processors (DSPs), digital signal processing devices (DSPDs), programmable logic devices (PLDs), field programmable gate arrays (FPGAs), processors, controllers, microcontrollers and/or microprocessors.

In the case of an implementation by firmware or software, an embodiment of the present invention may be implemented in the form of a module, procedure, or function for performing the aforementioned functions or operations. Software code may be stored in memory and driven by a processor. The memory may be located inside or outside the processor, and may exchange data with the processor through a variety of known means.

It is evident to those skilled in the art that the present invention may be materialized in other specific forms without departing from the essential characteristics of the present invention. Accordingly, the detailed description should not be construed as being limitative from all aspects, but should be construed as being illustrative. The scope of the present invention should be determined by reasonable analysis of the attached claims, and all changes within the equivalent range of the present invention are included in the scope of the present invention.

### INDUSTRIAL APPLICABILITY

The aforementioned preferred embodiments of the present invention have been disclosed for illustrative purposes, and those skilled in the art may improve, change, substitute, or add various other embodiments without departing from the technological spirit and scope of the present invention disclosed in the attached claims.

1. A method for decoding an image, comprising:
generating a prediction block of a current processing block by using a prediction mode of the current processing block,
wherein the current processing block indicates a block in which a leaf node block partitioned into a quadtree structure from a basic unit partitioning a picture is partitioned into a binary tree structure;
determining whether a skip mode is applied to the current processing block; and
generating a residual block of the current processing block, when the skip mode is not applied for the current processing block,
wherein the step of generating the residual block includes decoding a syntax element indicating whether a residual signal is existed in a chroma component of the current processing block.

2. The method of claim 1, wherein the step of generating the residual block comprising:
decoding a syntax element indicating whether a residual signal is existed in a luma component of the current processing block, when a residual signal is existed in the chroma component.

3. The method of claim 2, when a residual signal is not existed in the chroma component, wherein the residual signal is estimated to be existed in the luma component.

4. The method of claim 1, further comprising:
determining whether a merge mode is applied to the current processing block, when a prediction mode of the current processing block is an inter-prediction mode; and
decoding a reference picture index and a motion vector difference value of the current processing block, when the merge mode is not applied to the current processing block,
wherein the step of generating the residual block comprising:
decoding an Advanced Motion Vector Prediction (AMVP) skip flag indicating that a decoding syntax of a residual block is not existed in an AMVP mode.

5. The method of claim 4, wherein the step of generating the residual block comprising:
decoding a syntax element indicating whether a residual signal is existed in a luma component of the current processing block, when the AMVP flag indicates 0 and the residual signal is not existed in the chroma component.

6. An apparatus for decoding an image, comprising:
a prediction block generation unit for generating a prediction block of a current processing block by using a prediction mode of the current processing block,
wherein the current processing block indicates a block in which a leaf node block partitioned into a quadtree structure from a basic unit partitioning a picture is partitioned into a binary tree structure;
a skip mode determination unit for determining whether a skip mode is applied to the current processing block; and
a residual block generation unit for generating a residual block of the current processing block, when the skip mode is not applied for the current processing block,
wherein the residual block generation unit decodes a syntax element indicating whether a residual signal is existed in a chroma component of the current processing block.

7. The apparatus of claim 6, wherein the residual block generation unit decodes a syntax element indicating whether a residual signal is existed in a luma component of the current processing block, when a residual signal is existed in the chroma component.

8. The apparatus of claim 7, when a residual signal is not existed in the chroma component, wherein the residual signal is estimated to be existed in the luma component.

9. The apparatus of claim 6, further comprising:
a merge mode determination unit for determining whether a merge mode is applied to the current processing block, when a prediction mode of the current processing block is an inter-prediction mode; and
a motion information decoding unit for decoding a reference picture index and a motion vector difference value of the current processing block, when the merge mode is not applied to the current processing block,
wherein the residual block generation unit decodes an Advanced Motion Vector Prediction (AMVP) skip flag indicating that a decoding syntax of a residual block is not existed in an AMVP mode.

10. The apparatus of claim 9, wherein the residual block generation unit decodes a syntax element indicating whether a residual signal is existed in a luma component of the current processing block, when the AMVP flag indicates 0 and the residual signal is not existed in the chroma component.
